(19) United States
(12) Patent Application Publication
(10) Pub. No.: US 2021/0042568 A1
(43) Pub. Date: Feb. 11, 2021

(54) PATTERN MODEL ASSEMBLY

(71) Applicant: William C. Meysing, Corbett, OR (US)

(72) Inventor: William C. Meysing, Corbett, OR (US)

(21) Appl. No.: 16/892,151

(22) Filed: Jun. 3, 2020

Related U.S. Application Data
(60) Provisional application No. 62/856,559, filed on Jun. 3, 2019.

(51) Int. Cl. G06K 9/62; G06F 3/0484

(52) U.S. Cl. CPC G06K 9/6215; G06F 3/04842; G06K 9/6202

(57) ABSTRACT

Methods, devices, and systems for human identity pattern detection. The method may include retrieving, using at least one processor, a plurality of identity pattern statement sets from computer memory accessible to the at least one processor, wherein each identity pattern statement set of the plurality comprises a plurality of identity pattern statements; rendering a first identity pattern statement set of the plurality identity pattern statement sets for a first human; rendering a second identity pattern statement set of the plurality identity pattern statement sets to the first human; providing a user-interface configured to allow selection by the first human of a first identity pattern statement from the first identity pattern statement set and a second identity pattern statement from the second identity pattern statement set; generating a first identity pattern footprint associating the first identity pattern statement and the second identity pattern statement with a user identifier associated with the first human.

### CROSS-REFERENCE TO RELATED APPLICATION

This application claims the benefit of Provisional Patent Application Ser. No. 62/856,559, filed Jun. 3, 2019, which is incorporated herein by reference in its entirety.

### BACKGROUND OF THE DISCLOSURE

The complexities of human behavior are difficult to quantify or predict. Human interaction is often made more difficult by differences in beliefs and patterns of thought.

### SUMMARY OF THE DISCLOSURE

In aspects, this disclosure generally relates to a method for human identity pattern detection. The method may include retrieving, using at least one processor, a plurality of identity pattern statement sets from computer memory accessible to the at least one processor, wherein each identity pattern statement set of the plurality comprises a plurality of identity pattern statements; rendering a first identity pattern statement set of the plurality identity pattern statement sets for a first human; rendering a second identity pattern statement set of the plurality identity pattern statement sets to the first human; providing a user-interface configured to allow selection by the first human of a first identity pattern statement from the first identity pattern statement set and a second identity pattern statement from the second identity pattern statement set; generating a first identity pattern footprint associating the first identity pattern statement and the second identity pattern statement with a user identifier associated with the first human.

Methods may include rendering a representation of the first identity pattern footprint; performing a pattern matching analysis on the first identity pattern footprint using a pattern matching heuristic; rendering a third identity pattern statement set, a fourth identity pattern statement set, a fifth identity pattern statement set, a sixth identity pattern statement set, and a seventh identity pattern statement set. Each identity pattern statement set may consist of seven identity pattern statements.

Methods may include performing a pattern matching analysis on the first identity pattern footprint by comparing the first identity pattern footprint with at least one standard identity pattern footprint; determining an optimal matching identity pattern footprint from the at least one standard identity pattern footprint; and taking a diagnostic action in dependence upon the optimal matching identity pattern footprint.

Methods may include rendering the first identity pattern statement set of the plurality identity pattern statement sets for a second human; rendering the second identity pattern statement set of the plurality identity pattern statement sets to the second human; providing a user-interface configured to allow selection by the second human of a third identity pattern statement from the first identity pattern statement set and a fourth identity pattern statement from the second identity pattern statement set; generating a second identity pattern footprint associating the third identity pattern statement and the fourth identity pattern statement with a second user identifier associated with the second human. Methods may include performing a pattern matching analysis by comparing the first identity pattern footprint with the second identity pattern footprint; and taking a diagnostic action in dependence upon the pattern matching analysis. Comparing the first identity pattern footprint with the second identity pattern footprint may comprise generating a similarity metric, and the diagnostic action is dependent upon the similarity metric. The similarity metric may be dependent upon whether the first identity pattern statement is identical to the third identity pattern statement or whether the second identity pattern statement is identical to the fourth identity pattern statement. Performing a pattern matching analysis comprises using a heuristic comprising a plurality of rules.

Examples of the more important features of the disclosure have been summarized rather broadly in order that the detailed description thereof that follows may be better understood and in order that the contributions they represent to the art may be appreciated.

### DETAILED DESCRIPTION

This disclosure generally relates to methods and systems for human identity pattern detection. Human identity is based on a core set of values, beliefs, and convictions, along with sociological and psychological traits. Patterns in characteristics of identity, when detected, may be employed to build better teams, facilitate relations between individuals or groups of people, select well-matched companions, and provide identity-tailored help and instruction in a variety of areas.

Aspects of the present disclosure use a collection of a person's choices to build a footprint which describes their core values and beliefs. This footprint may then be leveraged to perform the actions above.

Participants make choices from a selection of options in a set. Several sets may be used, and each set may be organized around a central theme. The choices are rendered for selection. Each choice is an identity pattern statement. The term statement is not limited to words, and may also include images, single words, or ideas. In some embodiments, the statement may be a famous quote.

Participants may first select four statements in each set. Each set may contain seven statements, and there may be seven sets, although other configurations will occur to those in the art. An additional selection may be performed from the initial four selections for each set.

In a teambuilding example, the seven sets may correspond with sequenced stages of teamwork success themes, resulting in a 28 quote choice pattern. Thus the fingerprint is representative of chosen teamwork success quotes or the like. The pattern represents each participant's personal vision and attitudes about work team unity and job performance commitment.

The footprint of each participant may be compared with each other or with a team leader. A tally of how many of a particular participant's quote selections match-up with the team leader's 28 quote choices. The occurrence of the tally reaching or exceeding a threshold (e.g., 15) may indicate a unity deepening connection between the particular coworker and the team leader. Different thresholds may be used for each set.

Software executing on one of a variety of environments may embody the methods described herein.

FIG. 2 is a diagram of a system in accordance with embodiments of the present disclosure. The pattern matching system 200 includes a number of devices connected by networks for data communications. The system 200 includes wide area networks (‘WAN’), such as the Internet. In other embodiments, however, the devices of FIG. 2 may be connected by local area networks (‘LAN’s), intranets, internets, the Internet, wireless networks, cellular networks, or any other type of communication network, or combinations of these.

A first client device 202 is in connection with a pattern matching server 204, and is used by a first human. Similarly, a second client device 212 is also in connection with pattern matching server 204. In other embodiments, client devices may connect to additional third-party servers, which are in connection with the pattern matching server, which serves as a central platform. The client devices may be personal computers accessing the pattern matching server 204 through a web browser interface, or may be mobile devices utilizing downloaded app software. Some data may be warehoused on the mobile device or computer.

These servers may include web servers and/or application servers connected to a database in local or remote storage. Server 204 may store and manage account information, client preferences, and footprints. Server 204 may include an analysis engine 232 and an action generator 234.

Client devices 202, 212 may be any of a desktop, workstation, laptop, smartphone, tablet, cellular telephone, and the like. Client devices 202, 212 may log in to servers (by using a web browser or a client application, for example) to enable the respective users to make selections of identity pattern statement, receive diagnostic information, view analysis, view matching users, and so on.

The analysis engine 232 may detect similarities and differences between a user footprint and other user footprints, including standard footprints indicative of a diagnostic type.

The analysis engine 232 may also pass detected differences in the iterative proposals to the action generator 234. The analysis engine 232 may compare footprints and/or the detected differences therein against a set of rules to characterize the user or to characterize a relation between users. The action generator performs diagnostic actions in dependence upon the analysis. The action generator 234 may also use system configuration data, historical data, reference data, preference data, and so on, in performing the appropriate action. These data may be stored locally or in network attached storage in various databases. Example actions may include notification of an optimal match, notification of a match within a threshold range, rendering of the footprint, rendering of a characterization of the user or a relation between users, prompting for additional data entry, transmitting additional information associated with analysis result, and so on.

Graphical user interface (‘GUI’) module 240 formats information from action generator for rendering at a client device. Data may be formatted as propriety or non-proprietary data sets for specially configured rendering by client software on the client device, or as HTML, XHTML, Flash, or other web-compatible data formats for rendering with a web browser such as Mozilla Firefox, Opera, or Google Chrome. Security module 250 may also conduct authentication and authorization procedures for anyone using the software.

The system may implement databases in data storage. The data storage may include any non-transitory computer-readable medium, either remotely or locally accessible, implemented with architectures including but not limited to cloud storage, network attached storage, storage area networks, etc. FIG. 3 sets forth a block diagram of an example information processing device used in embodiments of the present disclosure. Computer 302 includes at least one computer processor 354 as well as a computer memory, including both volatile random access memory (‘RAM’) 304 and some form or forms of non-volatile computer memory 350 such as a hard disk drive, an optical disk drive, or an electrically erasable programmable read-only memory space (also known as ‘EEPROM’ or ‘Flash’ memory). The computer memory is connected through a system bus 340 to the processor 354 and to other system components. Thus, the software modules are program instructions stored in computer memory.

An operating system 310 is stored in computer memory. Operating system 310 may be any appropriate operating system such as Windows 10, Windows 7, Mac OSX, UNIX, or LINUX. A network stack 312 is also stored in memory. The network stack 312 is a software implementation of cooperating computer networking protocols to facilitate network communications.

Computer 302 also includes one or more input/output interface adapters 256. Input/output interface adapters 356 may implement user-oriented input/output through software drivers and computer hardware for controlling output to output devices 372 such as computer display screens, as well as user input from input devices 370, such as keyboards and mice.

Computer 302 also includes a communications adapter 352 for implementing data communications with other devices 360. Communications adapter 352 implements the hardware level of data communications through which one computer sends data communications to another computer through a network.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, and/or use of equivalent functional actions for actions described herein. Such insubstantial variations are to be considered within the scope of the claims below.

Given the above disclosure of general concepts and specific embodiments, the scope of protection is defined by the claims appended hereto. The issued claims are not to be taken as limiting Applicant's right to claim disclosed, but not yet literally claimed subject matter by way of one or more further applications including those filed pursuant to the laws of the United States and/or international treaty.

What is claimed is:

1. A method for human identity pattern detection, the method comprising:
retrieving, using at least one processor, a plurality of identity pattern statement sets from computer memory accessible to the at least one processor, wherein each identity pattern statement set of the plurality comprises a plurality of identity pattern statements;
rendering a first identity pattern statement set of the plurality identity pattern statement sets for a first human;
rendering a second identity pattern statement set of the plurality identity pattern statement sets to the first human;
providing a user-interface configured to allow selection by the first human of a first identity pattern statement from the first identity pattern statement set and a second identity pattern statement from the second identity pattern statement set;
generating a first identity pattern footprint associating the first identity pattern statement and the second identity pattern statement with a user identifier associated with the first human.

2. The method of claim 1 further comprising rendering a representation of the first identity pattern footprint.

3. The method of claim 1 further comprising performing a pattern matching analysis on the first identity pattern footprint using a pattern matching heuristic.

4. The method of claim 1 further comprising rendering a third identity pattern statement set, a fourth identity pattern statement set, a fifth identity pattern statement set, a sixth identity pattern statement set, and a seventh identity pattern statement set.

5. The method of claim 4 wherein each identity pattern statement set consists of seven identity pattern statements.

6. The method of claim 1 further comprising performing a pattern matching analysis on the first identity pattern footprint by comparing the first identity pattern footprint with at least one standard identity pattern footprint; determining an optimal matching identity pattern footprint from the at least one standard identity pattern footprint; and taking a diagnostic action in dependence upon the optimal matching identity pattern footprint.

7. The method of claim 1, further comprising:
rendering the first identity pattern statement set of the plurality identity pattern statement sets for a second human;
rendering the second identity pattern statement set of the plurality identity pattern statement sets to the second human;
providing a user-interface configured to allow selection by the second human of a third identity pattern statement from the first identity pattern statement set and a fourth identity pattern statement from the second identity pattern statement set;
generating a second identity pattern footprint associating the third identity pattern statement and the fourth identity pattern statement with a second user identifier associated with the second human.

8. The method of claim 7 further comprising performing a pattern matching analysis by comparing the first identity pattern footprint with the second identity pattern footprint; and taking a diagnostic action in dependence upon the pattern matching analysis.

9. The method of claim 8 wherein comparing the first identity pattern footprint with the second identity pattern footprint comprises generating a similarity metric, and the diagnostic action is dependent upon the similarity metric.

10. The method of claim 9 wherein the similarity metric is dependent upon whether the first identity pattern statement is identical to the third identity pattern statement.

11. The method of claim 10 wherein the similarity metric is dependent upon whether the second identity pattern statement is identical to the fourth identity pattern statement.

12. The method of claim 7 wherein performing a pattern matching analysis comprises using a heuristic comprising a plurality of rules
